(19) United States
(12) Patent Application Publication
(10) Pub. No.: US 2004/0223292 A1
(43) Pub. Date: Nov. 11, 2004

(54) Interconnection of software and consumer electronics functional modules in multifunction devices

(76) Inventor: David Mark Anthony Murphy, Waldwick, NJ (US)

Correspondence Address: Mr. David M. Murphy, 23 Waldwick Avenue, Waldwick, NJ, 07463, US

(21) Appl. No.: 10/428,951

(22) Filed: May 5, 2003

(51) Int. Cl. G06F 1/16

(52) U.S. Cl. 361/679

(57) ABSTRACT

An infrastructure for encapsulating diverse consumer electronics and computer software functions into intelligent modules that can perform their function independently and can communicate with the host device and other modules. These modules are designed to be installed in multifunction devices that derive their capabilities solely from the function modules and the interconnections between them

### CROSS-REFERENCE TO RELATED APPLICATIONS

N/A

### STATEMENT REGARDING FEDERALLY SPONSORED RESEARCH OR DEVELOPMENT

N/A

### REFERENCE TO SEQUENCE LISTING, A TABLE OR COMPUTER PROGRAM LISTING APPENDIX

N/A

This invention relates to the arrangements to enable computer electronics and computer software functions to be encapsulated in functional modules, and it also relates to a multifunctional device that allows the said modules to be interconnected.

### BACKGROUND OF THE INVENTION

There has been a proliferation of consumer electronics devices which permeate our everyday lives, a typical person may have a Computer, TV, VCR, DVD Player, Stereo Radio and Telephone at home, a CD Player and GPS Receiver in their car and carry a mobile phone, mp3 player and a PDA around with them.

There have been many attempts to integrate similar functions into a single device such as PDA's with cell phone capabilities; indeed, many PDA manufacturers are attempting to turn their products into multi functional devices by producing proprietary add-on modules to their PDA's architecture. However, these attempts are small scale, proprietary, limited to dual function and have little to no interaction with the host device.

### SUMMARY OF THE INVENTION

The object of the invention is to provide a means by which the functions currently provided by many consumer electronics devices and computer software can be encapsulated in a standard module and then incorporated in a single device.

According to the invention, the function module device measures approximately 46 mm×32 mm×10 mm and houses the functional circuitry of one of many consumer electronics devices, or computer software, which performs a particular function, also a control circuit board consisting of memory and EPROM chips containing the operating software.

The onboard software will be responsible for managing the input, output and general operation of its main board functionality and for communicating with a host device.

The aforementioned host device portion of the invention is a multifunction device that has no inherent function until function modules are installed. These multifunction devices can take any form according to its perceived primary use, for example a TV style multifunction device would be sold with the TV Tuner function module pre-installed, and would externally appear to be identical to a regular Television set, but it would have several other slots available for additional modules, giving it unlimited potential.

There are many advantages of this approach.

For the consumer, one benefit is that the functions can be interchanged between any device that supports them, For example, a user could listen to his MP3 collection, stored on an MP3 Module, through his household TV style multifunction device, transfer it to an In-Car entertainment style multifunction device and later transfer it to his PDA style multifunction device once he arrives at his destination.

Similarly a user with one multifunction device and a range of modules could configure his device to perform the functions that would have previously required carrying several separate devices.

Another advantage arises from the module's ability to communicate with the host device and other modules, the output of one module could be piped to the input of another module and so forth to perform an unimaginable range of complex functions, for example, a multifunction device fitted with the mobile phone, handwriting recognition, voice recognition and text-to-speech modules would allow a deaf mute to communicate with someone on a regular phone; the output of the handwriting recognition module would be piped to the text-to-speech module whose output would be fed to the phone module; conversely the incoming speech would be routed to the voice recognition module which would then output text to the screen

### BRIEF DESCRIPTION OF THE DRAWINGS

FIG. 1 is a design specification for the function module portion of the invention FIG. 2 is a sample illustration of a multifunction device that supports up to 6 function modules.

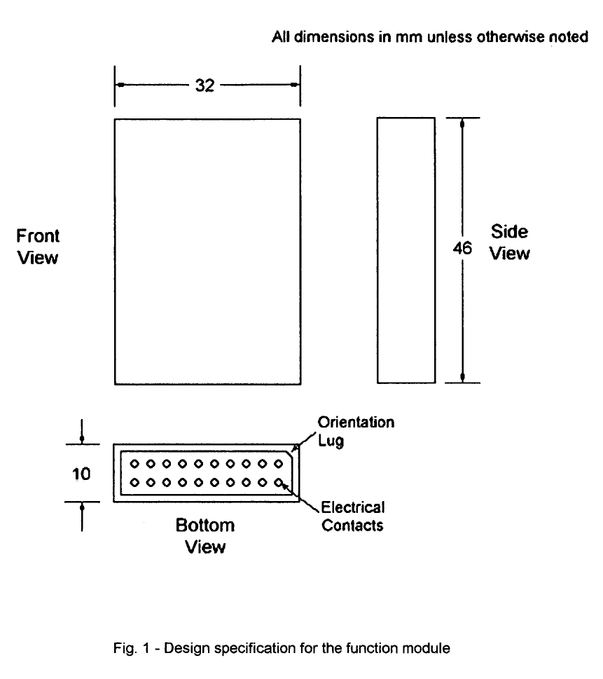

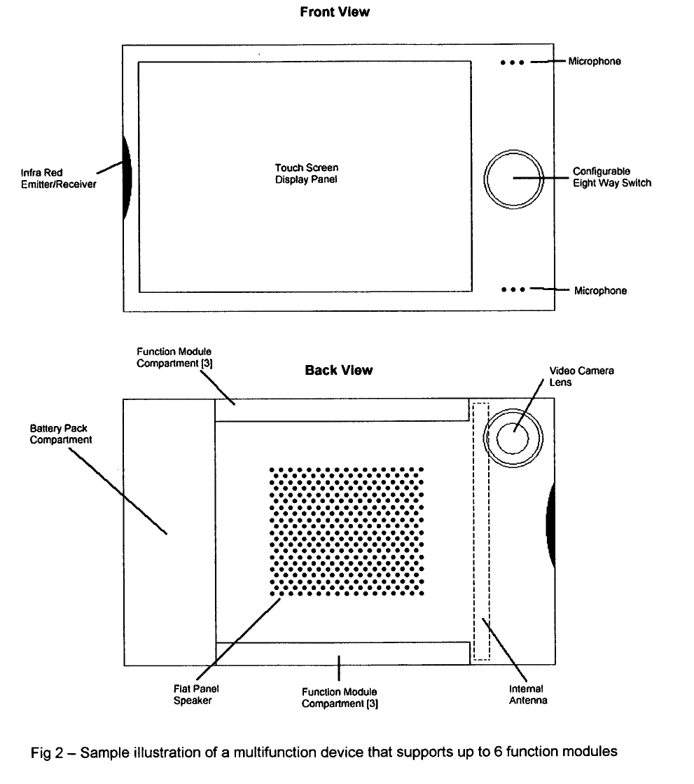

### DETAILED DESCRIPTION OF THE INVENTION

In accordance with the first aspect of the invention, a function module, comprises:

A rectangular sealed, waterproof case measuring approx 46 mm×32 mm×10 mm, having electrical contacts exposed at one end and a lug to ensure correct orientation;

One or more printed circuit boards with the functional circuitry or computer software necessary to perform a specific task, for example, in the case of a mobile phone, a physical function, the functional circuitry would be the bare circuit board required to make and receive phone calls, without the keypad, microphone, speakers, antenna, display or battery and in the case of voice recognition software, a logical function, the functional circuitry would be enough EPROM and memory chips to independently store and execute the software.

A printed circuit board connected to the main board(s) containing the necessary software to control the operation of the device and to communicate with the host device into which it is installed and to other function modules connected to the host device. The function module once connected to a host device, would be queried by the host, the controller board would then export its description, the command list it exposes, input/output specifications and even HTML code for a default user interface using XML, for example, a video movie module, when queried, might output the following XML stream to the host:

<DEVICE>

<NAME>MOVIE</NAME>
<TITLE>The Matrix</TITLE>
<ABOUT>

<HTML>
<BODY><H2>The Matrix</H2>
Starring Keanu Reeves...
</BODY>
</HTML>

</ABOUT>
<COMMANDLIST>

<FUNCTION>PLAY</FUNCTION>
<FUNCTION>STOP</FUNCTION>
<FUNCTION>PAUSE</FUNCTION>
<FUNCTION>REWIND</FUNCTION>
<FUNCTION>FORWARD</FUNCTION>

</COMMANDLIST>
<OUTPUT TYPE=“VIDEO” />
<OUTPUT TYPE=“AUDIO” />
<DEFAULTUI>

<HTML>
<BODY>
...
</BODY>
</HTML>

</DEFAULTUI>

</DEVICE>

From this data stream, the host device would be able to determine what commands it can execute, how to route data to and from the module and how to render its default user interface.

In accordance with the second aspect of the invention, a host device is apparatus that can be either single function or multifunctional design, having any shape or form according to its perceived primary use, for example, an in-car-entertainment style multifunction device would be designed to fit the standard aperture for vehicle CD Player/Radio/Cassette equipment and also resemble current models but it would contain slots for additional function modules.

These devices would have no inherent capabilities; it would be a unit with an array of inputs and outputs connected to a standard bus, into which one or more function modules could be connected.

The devices would feature an event driven, possibly browser based, basic input/output operating system which could query and execute commands on the function modules connected to its bus, provide a user interface and menu system, if required, and handle the routing of the various inputs and outputs, for example, a Global Positioning System function module might provide its output as latitude and longitude coordinates in XML format thusly:

<OUTPUT TYPE=“COORDINATE”>

<LATITUDE>40° 54′ N</LATITUDE>
<LONGITUDE>74° 9′ W</LONGITUDE>

</OUTPUT>

A multifunction device fitted with a display screen would be able to display the raw coordinates to the user, however, if a US Ordinance Survey Map function module is installed then the output of the GPS module could be routed to the mapping module, which could then display the users current position on a map. The mapping module would specify <INPUT TYPE=“COORDINATE”> in its input specification allowing the operating system to route the data and display it.

Single function devices would be simply shells which house its user interface, power supply and any other external connections, for example, a mobile phone shell would have a keypad, LCD display, battery pack, external antenna, a very basic operating system to query and recognize a mobile phone function module and a slot for a single module which would contain the mobile phone's functional component.

These shells would be externally indistinguishable from current products except that the function module at their heart would be ready for use in multifunction devices

I claim:

1. An electronic device or module comprising
a rectangular sealed, waterproof case measuring approx 46 mm×32 mm×10 mm, having electrical contacts exposed at one end and a lug to ensure correct orientation;
one or more electronic circuit boards with the function circuitry or computer software necessary to perform a specific task i.e. mobile phone or text-to-speech
an additional electronic circuit board connected between the main board(s) and the electrical contacts with computer software that has full control over the operation of the main board(s) and communicates with other devices using the XML language or other data protocol, acting as a broker between the functional circuitry and other modules and/or a host device

2. A connection arrangement to allow the transmission and reception of XML data, digital audio, video and other digital signals between connected modules as described in claim 1, and a host device.

3. A device dedicated to performing a single function, equipped with all the necessary input/output peripherals, such as, battery, antenna, speaker, microphone, display and keypad in the case of a mobile phone, a slot to hold a single function module according to claim 1, which houses the core functionality to perform the task, and a basic operating system to act as a broker between the user interface and the function module described in claim 1 using the connection arrangement described in claim 2

4. A device that can have ANY form with as many input/output peripherals as it's design allows, for example, a jacket may have a microphone and speakers built into the collar, an antenna sewn into the back lining, a small touchscreen display built into the sleeve, two or more slots for function modules described in claim 1, and a basic event driven operating system capable of detecting a function module connection event, querying the module, receiving its inpuvoutput specification, providing a user interface and route user input and function module output to the said device's output peripherals as well as the inputs of other function modules; such a device would be able to perform at least as many functions as the number of function modules connected to it as well as additional functions arising from the interconnection between the modules.
